(19) United States
(12) Patent Application Publication
(10) Pub. No.: US 2018/0047026 A1
(43) Pub. Date: Feb. 15, 2018

(54) SYSTEM AND METHOD FOR AUTHENTICATING A SECURE PAYMENT TRANSACTION BETWEEN A PAYER AND A PAYEE

(71) Applicant: Anand Vaidyanathan, Chennai (IN)

(72) Inventor: Anand Vaidyanathan, Chennai (IN)

(21) Appl. No.: 15/673,436

(22) Filed: Aug. 10, 2017

(30) Foreign Application Priority Data
Aug. 12, 2016 (IN) 201641027730

(51) Int. Cl. G06Q 20/40; G06Q 20/10; G06Q 20/38

(52) U.S. Cl. CPC G06Q 20/40145; G06Q 20/4012; G06Q 20/3829; G06Q 20/108; G06Q 2220/00

(57) ABSTRACT

Disclosed is a payment authentication system and method for secure payment transaction using a payment authentication server. The payment authentication system includes a payer 102, a payer connector 104, a payee device 106, a payment authentication server 108, a payer device 110, a payment authentication system 112, a payment authentication exchange server 114, a payer bank server 116, a payee bank server 118 and the payee 120. The method is versatile and allows the one or more payers 102 to securely transfer the payment to one or more payers 120 in either 2-factor authentication or 3-factor authentication.

### CROSS REFERENCE TO RELATED APPLICATIONS

This application claims priority to Indian patent application no. 201641027730 filed on Aug. 12, 2016, the complete disclosure of which, in its entirely, is herein incorporated by reference.

### BACKGROUND

### Technical Field

Embodiments of this disclosure generally relate to an authentication, and more particularly, to a system and method of authenticating a transaction between a payer and a payee using payment authentication server.

### Description of the Related Art

In the modem times, cashless transaction has become a norm because of the obvious advantage over carrying cash. For one, exact amount of cash required need not be anticipated, and secondly it facilitates more secure transaction over cash payment.

Usually cashless transactions are managed using a magnetic card with sixteen digit card number. This payment could be online or offline. At the time of online payment, user has to manually punch in cvv or pin etc to confirm the transaction. This method is cumbersome & requires diligence from the user for security of his pin. Besides, unauthorized transactions can be made by man in the middle attack or phishing in case of online operations. Similarly, offline transaction is permitted on the card by providing the pin. It is easy for a fraudster to access the pin & perform unauthorized transactions using the card of original user.

Due to these limitations of existing methods, user has to diligently secure his card & pin. Also, he has no flexibility of sharing the card with anyone as he has no control over the transaction if his card is with someone else along with a pin number. It is a limitation when user wants to control the transaction but at the same time wants to share the card. e.g. with children or with servants for specific or limited transactions.

Accordingly, there remains a need for a secure method of payment between a payer and payee for more secure transactions & reducing the security burden on card making it more flexible to use.

### SUMMARY

In view of the foregoing, an embodiment herein provides a payment authentication system and method for secure payment transaction between a payer and a payee using a payment authentication server. The payment authentication server includes a memory unit, and a processor. The memory unit stores a set of modules and a payment server database. The payment database server stores (a) a payer data that includes at least one of (i) a payer connector or identifying information (ii) said payer name, (iii) payer bank account details, (iv) a PIN number, (v) a Mobile Number and Machine/Software ID, (vi) a password, (vii) a finger print of said payer, and (viii) an iris scan of said payer,(viii) private and public key pairs used to establish identity and (b) a payee data comprises, (i) payee name, (ii) payee identifier information and (iii) payee bank account details. The processor executes the set of modules. The set of modules includes a payment transaction data receiving module, a payer authentication request module, a payer authentication receiving module, a payment transaction module, and a payment transaction status notification module. The payment transaction data receiving module is configured to (i) receive a payment transaction data from a payee device when the payment is initiated by the payer using the payer connector or a payee bank server when the payment is initiated by the payer by entering a unique identifying number on the payee online device or payee offline device, and (ii) identifies the payer by comparing the payment transaction data with the payer data stored in the payment server database. The payment transaction data includes (a) a unique identifier of the payer, and (b) a payment data of the payee which is required for processing the payment. The payer authentication request module is configured to communicate a request to the payer device for authenticating the payment transaction data of the payer. The payer authentication receiving module is configured to receive the payer authentication data from the payer device for verification. The payer authentication data is verified by comparing the payer authentication data with the payer data stored in the payment server database. The payer authentication data includes at least one of (i) the mobile number, machine ID or Software ID on device (ii) the password in a 2nd factor authentication, (iii) a fingerprint or an Iris scan or (iv) encryption key pairs in a 3 factor authentication. The payment transaction module is configured to communicate the payment information to a payment authentication exchange server to initiate a payment transaction when the payer authentication is verified. The payment authentication exchange server communicates with a payer bank server and a payee bank server to process the payment. The payment transaction status notification module is configured to communicate a notification to the payer device and either the online payee device or the offline payee device when the payment transaction is completed. The notification includes at least one of (i) the payment transaction is successful, (ii) the payment transaction is cancelled, or (iii) the payment transaction is pending.

According to an embodiment, the payer device includes a payer authentication request receiving module, a payer authentication data communication module, and a payment transaction status notification receiving module. The payer authentication request receiving module is configured to receive the request from the payment authentication server to allow the payer to provide the payer authentication data. The payer authentication data communication module is configured to communicate the payer authentication data to the payment authentication server. The payment transaction status notification receiving module is configured to receive the notification from the payment authentication server.

According to another embodiment, the online payee device or the offline payee device includes a unique identification data obtaining module, a payment transaction data communication module, and a payment transaction status notification receiving module. The unique identification data obtaining module configured to obtain the unique identification data of the payer when the payer initiate said payment from the connector or payee bank server. The payment transaction data communication module is configured to communicate the payment transaction data to the payment authentication server. The payment transaction status notification receiving module is configured to receive the notification from the payment authentication server.

According to one embodiment, the payer communicates payer authentication data to the payment authentication server only using the payer device.

According to yet another embodiment, the payer connector is a credit card, or a debit card. The payer payment data is stored in the connector using at least one of a) a QR code, b) a sound tag, c) chip technology, d) magnetic strip, e) RFID or f) Plain printed numbers or text.

According to yet another embodiment, the payment authentication server is connected to a one or more of a) payer devices and b) payee devices for processing said payment initiated by the one or more of payers.

According to yet another embodiment, the payer authentication data further includes: (i) a Mobile number, (ii) a Machine ID, (iii) a software ID of the registered payer device or (iv) Encryption key pairs used to establish identity.

In one aspect, a method for processing a payment initiated by a payer using a connector and a payer device to a payee through a payment authentication server, includes (i) obtaining, using either a online payee device or an offline payee device, a unique identification data of the payer when the payer initiate said payment from a connector, (ii) communicating, using the payment transaction data communication module, a payment transaction data to the payment authentication server, (iii) receiving, using the payment transaction data receiving module, the payment transaction data from the payee online device or said payee offline device for verification, (iv) communicating, using a payment authentication server, a payer authentication request to a payer device for authenticating the payment transaction data of said payer, (v) receiving, using the payer device, a request for authenticating the payment transaction data from the payment authentication server; (vi) communicating, using the payer device, a payer authentication data to the payment authentication server; (vii) receiving, using said payment authentication server, the payer authentication data for the verification; (viii) communicating, using payment authentication server, a verified payment data to the payment authentication exchange server, that is required to process the payment initiated by said payer; (ix) processing, using the payment authentication exchange server, the payment initiated by the payer, (x) communicating, using payment authentication server, a payment status notification to the payer device and the online payee device or offline payee device when payment transaction is completed, and (xi) receiving, using the payer device and the online payee device or offline payee device, the payment status notification communicated by the payment authentication server. The payment transaction data includes (a) the unique identifier of the payer and (b) a payment data of the payee which is required for processing the payment.

The payer is authenticated by comparing the payer authenticating data with the payer data stored in the payment server database. The payer is identified by comparing payment transaction data with a payer data store in a payment server database. The payer device is a mobile phone. The payer is authenticated by comparing the payer authenticating data with said payer data stored in said payment server database. The payment authentication exchange server communicates with both a payer bank server and a payee bank server for processing the payment. The notification includes at least one of (a) the payment transaction is successful, (b) the payment transaction is cancelled, or (c) the payment transaction is pending.

According to an embodiment, the payer data includes at least one of: (i) the payer name, ii) payer bank account details, iii) a PIN number, (iv) a finger print, (v) an Iris scan, (vi) a password, (vii) a Mobile number, (viii) a software ID on the payer device, (ix) a Machine ID of the payer device, (x) public and private key pairs in asymmetric encryption.

According to another embodiment, the connector is a credit card, or a debit card or a Unique Identifying number. The payer payment data is stored in the connector using at least one of a) a QR code, b) a sound tag, c) chip technology, d) magnetic strip, e) RFID, or f) written alphanumeric text.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view for authenticating a transaction between a payer and a payee using a payment authentication server according to an embodiment herein;

FIG. 2 illustrates an exploded view of the payment authentication server of FIG. 1 according to an embodiment herein;

FIG. 3 illustrates an exploded view of the payer device of FIG. 1 according to an embodiment herein;

FIG. 4 illustrates an exploded view of either the online payee device 106 or the offline payee device 107 of FIG. 1 according to an embodiment herein;

FIG. 5 is an interaction diagram illustrating a process for authenticating a transaction between a payer and a payee using a payment authentication server of FIG. 1 according to an embodiment herein;

FIG. 6A-6B are flow diagrams illustrating a method for processing a payment initiated by a payer using a connector and a payer device to a payee through a payment authentication server according to an embodiment herein;

FIG. 7 illustrates an exploded view of a personal communication device according to the embodiments herein; and

FIG. 8 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

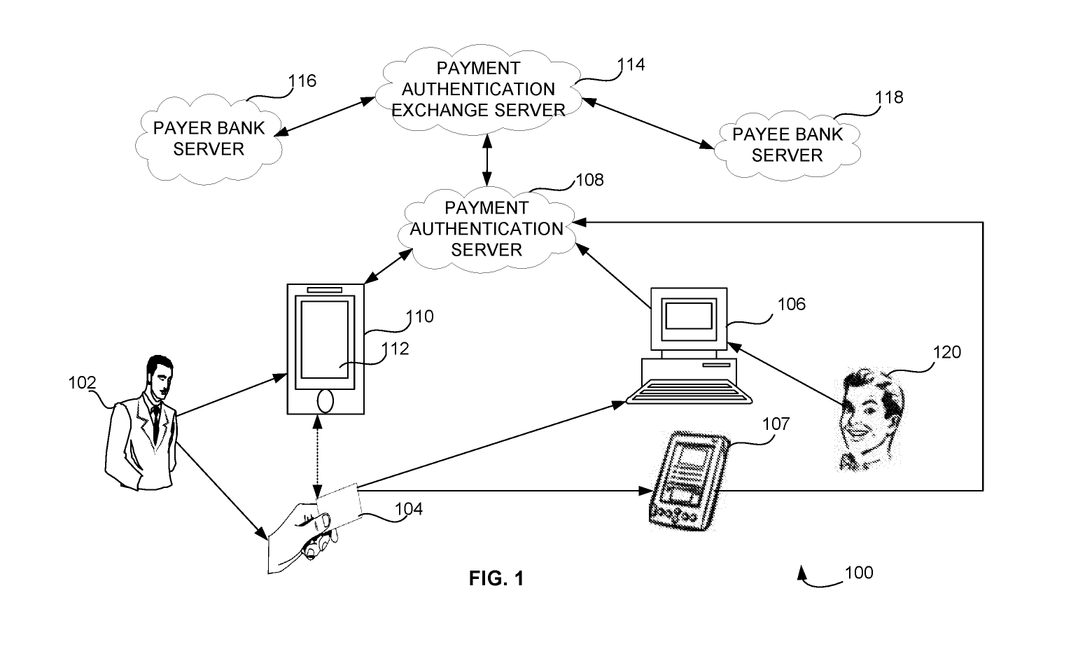

As mentioned, there remains a need for a secure method of payment between a payer and payee for more secure transactions & reducing the security burden on card making it more flexible to use. The embodiments herein achieve this, by providing a system and method for secure payment initiated by the payer to the payee through a payment authentication server. Referring now to the drawings, and more particularly to FIG. 1 through FIG. 7, where similar reference characters denote corresponding features consistently throughout the figures, there are shown preferred embodiments.

FIG. 1 illustrates a system view 100 for authenticating a transaction between a payer 102 and a payee 120 using a payment authentication server 108 according to an embodiment herein. The system view includes a payer 102, a payer connector 104, a online payee device 106, an offline payee device 107, a payment authentication server 108, a payer device 110, a payment authentication system 112, a payment authentication exchange server 114, a payer bank server 116, a payee bank server 118 and the payee 120.

The payer 102 initiates a payment by giving a payment transaction data using the payer connector 104 on the online payee device 106 and the offline payee device 107. In an embodiment, the payment is initiated by the payer 102, when the online payee device 106 or the offline payee device 107 obtains a unique identification data of the payer 102 from the payer 102. The online payee device 106 or the offline payee device 107 communicates a payment transaction data with the payment authentication server 108. The payment authentication server 108 sends request to the payer device 110. The payer 102 sends a payer authentication data to the payment authentication server 108 from the payer device 110 in response to the request received from the payment authentication server 108. In one embodiment, the payer 102 sends the payer authentication data using the payment authentication system 112 in the payer device 110. The payment authentication server 108 receives a payer authentication data from the payer 102 for verification. The payment authentication server 108 verifies the payer 102 and the payee 120 by comparing i) the payer data and ii) the payee data initially stored in a payment server database 202 with iii) the payment transaction data received from either online payee device 106 or offline payee device 108 and iv) payment authentication data received from the payer device 110.

In one embodiment, the payer authentication data comprises at least one of i) the PIN number, (ii) the password in a 2^{nd} factor authentication, (iii) a fingerprint or an Iris scan in a 3 factor authentication. In one embodiment, the payer data includes (i) a payer connector data or identifying information (ii) a payer name, (iii) payer bank account details, (iv) a PIN number, (v) a Mobile Number and Machine/Software ID, (vi) a password, (vii) a finger print of the payer, (viii) an iris scan of the payer, and (ix) encryption key pairs used to establish identity. In one embodiment, the payee data includes (i) payee name, (ii) payee identifier information and (iii) payee bank account details. In one embodiment, the payment authentication system 112 allows the payer 102 to enter his/her authentication data using the payer device 110. The payment authentication server 108 communicates with the verified data to a payment authentication exchange server 114. The payment authentication exchange server 114 processes the payment by communicating with a payer bank server 116 and a payee bank server 118. In one embodiment, the payment authentication exchange sever 114 communicates with the payer bank server 116, and the payee bank server 118 and enables the transaction from a payer bank account to a payee bank account. The payment authentication exchange server 114 sends a notification to both the payer device 110 and either the online payee device 106 or the offline payee device 107. In one embodiment, the notification includes at least one of (i) the payment transaction is successful, (ii) the payment transaction is cancelled, or (iii) the payment transaction is pending.

In one embodiment, the payer device 110 is a wireless mobile communication device, such as a cell phone, smart phone, tablet or personal digital assistance (PDA). In one embodiment, the online payee device 106 is a personal computer (PC), a handheld PC, a laptop, mobile phone, LAN, WLAN, wireless or wired network, website, or a cloud server. In another embodiment, the offline payee device 107 is a card reader or a PDE that is capable of detecting a credit card, or a debit card using at least one of a) a QR code, b) a sound tag, c) chip technology, d) magnetic strip, or e) RFID. In one embodiment, the payment authentication server 108 is a cloud server, etc. In one another embodiment, the payer bank server 116 is a personal computer (PC), a handheld PC, a laptop, LAN, WLAN, wireless or wired network. In yet another embodiment, the payee bank server 118 may be a personal computer (PC), a handheld PC, mobile phone, a laptop, LAN, WLAN, wireless or wired network.

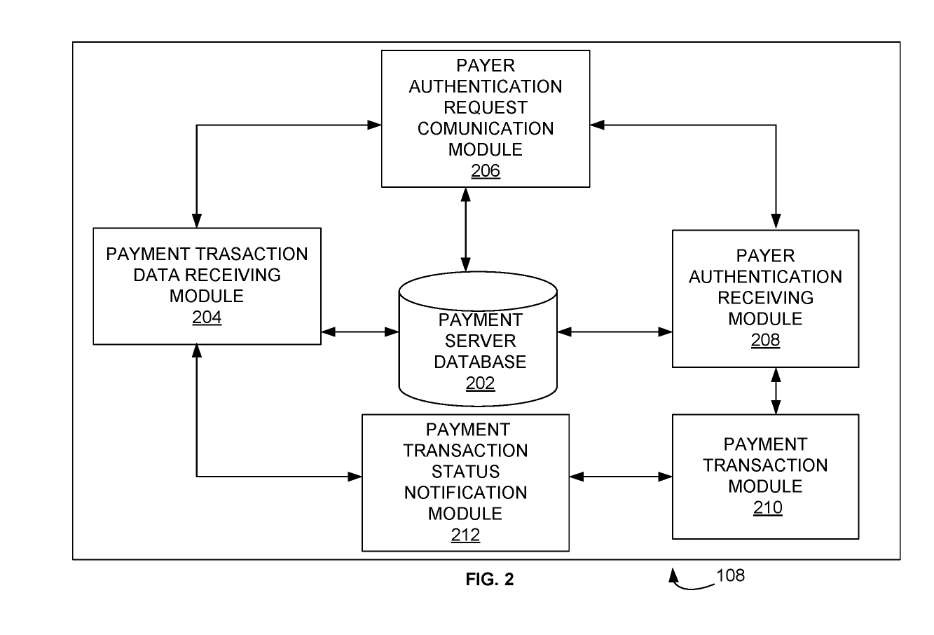

FIG. 2 illustrates an exploded view of the payment authentication server 108 of FIG. 1 according to an embodiment herein. The payment authentication server 108 includes a payment server database 202, a payment transaction data receiving module 204, a payer authentication request communication module 206, a payer authentication receiving module 208, a payment transaction module 210, and a payment transaction status notification module 210. The payment server database stores (a) a payer data that includes at least one of (i) a payer connector 104 or identifying information (ii) the payer name, (iii) payer bank account details, (iv) a PIN number, (v) a Mobile Number and Machine/Software ID, (vi) a password, (vii) a finger print of the payer, and (viii) an iris scan of the payer, (viii) encryption key pairs used to establish identity and (b) a payee data comprises, (i) payee name, (ii) payee identifier information and (iii) payee bank account details. The payment transaction data receiving module 204 is adapted to (i) receive a payment transaction data from either the online payee device 106 or the offline payee device 107 when the payment is initiated by the payer 102 using the payer connector 104 or a payee bank server 118. After the payment is initiated by the payer 102, by entering a unique identifying number the payment authentication server 108 identify the payer 102 by comparing the payment transaction data with the payer data stored in the payment server database 202. In an embodiment, the payment transaction data comprises (a) a unique identifier of the payer 102, and (b) a payment data of the payee 120 which is required for processing the payment. The payer authentication request communication module 206 communicates a request to the payer device 110 for authenticating the payment transaction data of the payer 102. The payer authentication receiving module 208 receives the payer authentication data from the payer device 110 for verification. In an embodiment, the payer authentication is verified by comparing the payer authentication data with the payer data stored in the payment server database 202. The payment transaction module 210 communicates the payment information to a payment authentication exchange server 114 to initiate a payment transaction when the payer authentication is verified. In an embodiment, the payment authentication exchange server 114 communicates with the payer bank server 116 and the payee bank server 118 to process the payment. The payment transaction status notification module 212 communicates a notification to the payer device 110 and either the online payee device 106 or the offline payee device 107 when the payment transaction is completed.

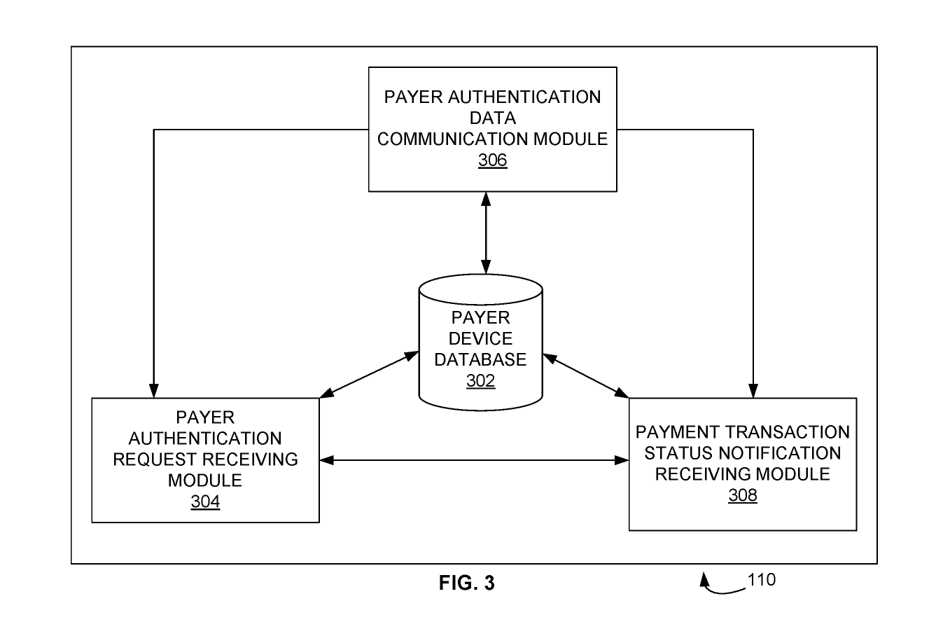

FIG. 3 illustrates an exploded view of the payer device 110 of FIG. 1 according to an embodiment herein. The payer device 110 includes a payer device database 302, a payer authentication request receiving module 304, a payer authentication data communication module 306, and a payment transaction status notification receiving module 308. The payer authentication request receiving module 304 receives the request from the payment authentication server 108 using the payment authentication system 112 to allow the payer 102 to provide said payer authentication data. The payer authentication data communication module 306 communicates the payer authentication data to the payment authentication server 108 using the payment authentication system 112. The payment transaction status notification receiving module 308 receives the notification from the payment authentication server 108 when the payment transaction is completed. In an embodiment, the notification comprises at least one of (i) the payment transaction is successful, (ii) the payment transaction is cancelled, or (iii) the payment transaction is pending. In one embodiment, the payer authentication data comprises at least one of i) the mobile number, software ID and/or Machine ID number, (ii) the password in a 2 factor authentication, (iii) a fingerprint or an Iris scan in a 3 factor authentication or (iv) encryption key pairs to establish identity.

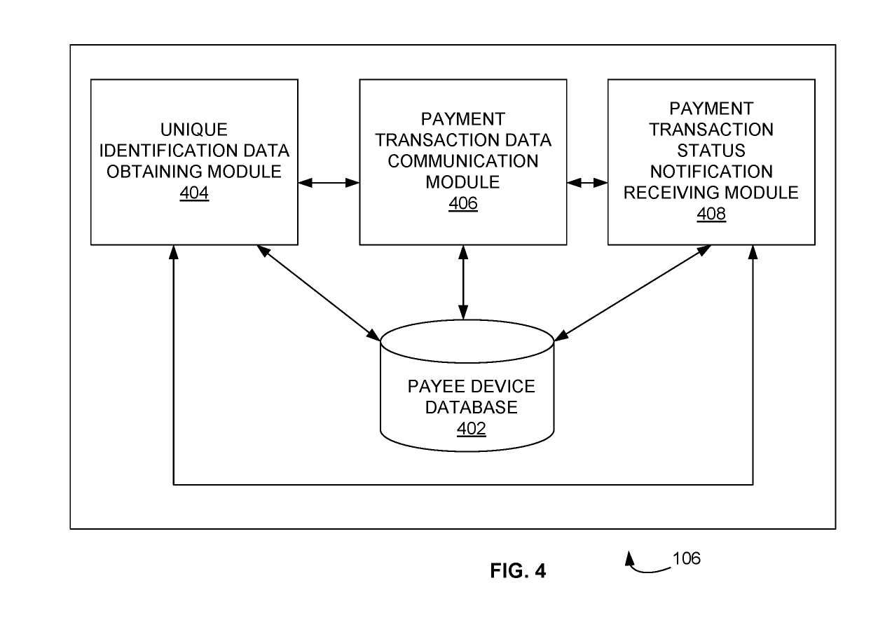

FIG. 4 illustrates an exploded view of either the online payee device 106 or the offline payee device 107 of FIG. 1 according to an embodiment herein. The online payee device 106 or the offline payee device 107 includes a payee device database 402, a unique identification data obtaining module 404, a payment transaction data communication module 406 and a payment transaction status notification receiving module 408. The unique identification data obtaining module 404 obtains the unique identification data of the payer 102 when the payer 102 initiates the payment from the connector 104. The payment transaction data communication module 406 communicates the payment transaction data to the payment authentication server 108. The payment transaction status notification receiving module 408 receives the notification from the payment authentication server 108.

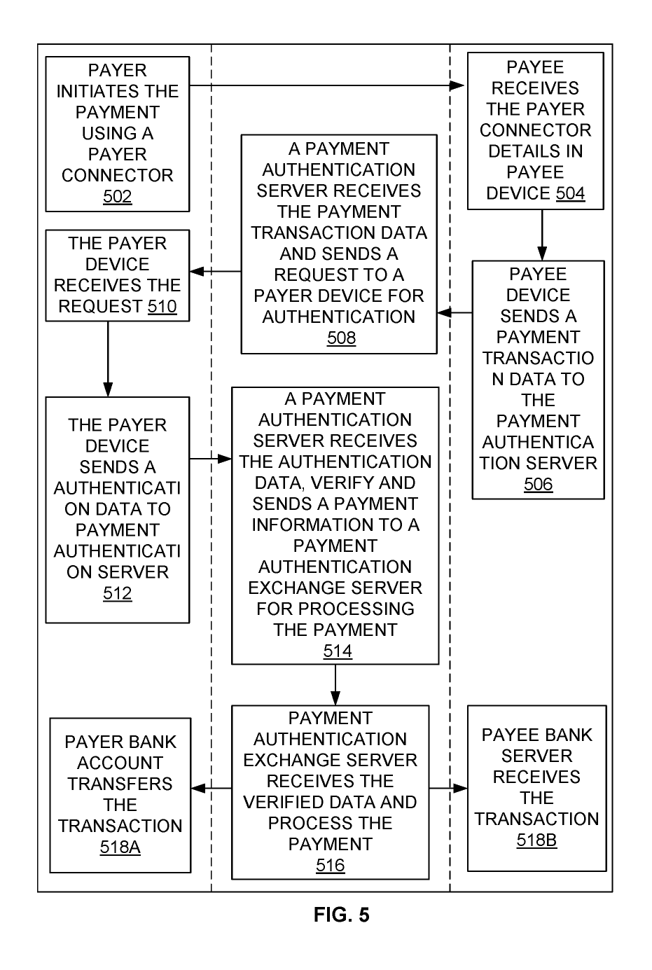

FIG. 5 is an interaction diagram illustrating a process for authenticating a transaction between the payer 102 and the payee 120 using the payment authentication server 108 of FIG. 1 according to an embodiment herein. At step 502, the payer initiates the payment transaction using a payment connector 104. At step 504, the payer 120 using the online payee device 106 or the offline payee device 107 obtains the unique identification data of the payer 102. At step 506, sends the payment transaction data to the payment authentication server 108. At step 508, on receiving the payment transaction data the payment authentication server 108 sends the request to the payer device 110. At step 510, the payer 102 receives the request in the using payer device 110. In one embodiment, the payer 102 receives the request in payer device 110 using the payment authentication system 112. The payer 102 sends the authentication data to the payment authentication server 108, at the step 512. At step 514, the payment authentication server 108 receives the authentication data of the payer 102, verify and send to the payment authentication exchange server 114. At step 516, the payment authentication exchange server 114 communicates with the payer bank server 116 and the payee bank server 118 to processes the payment transaction initiated by the payer 102. At step 518A and 518B, the payer device 110 and the online payee device 106 or the offline payee device 107 receives a notification from the payment authentication exchange server 114 on completion of the payment transaction process.

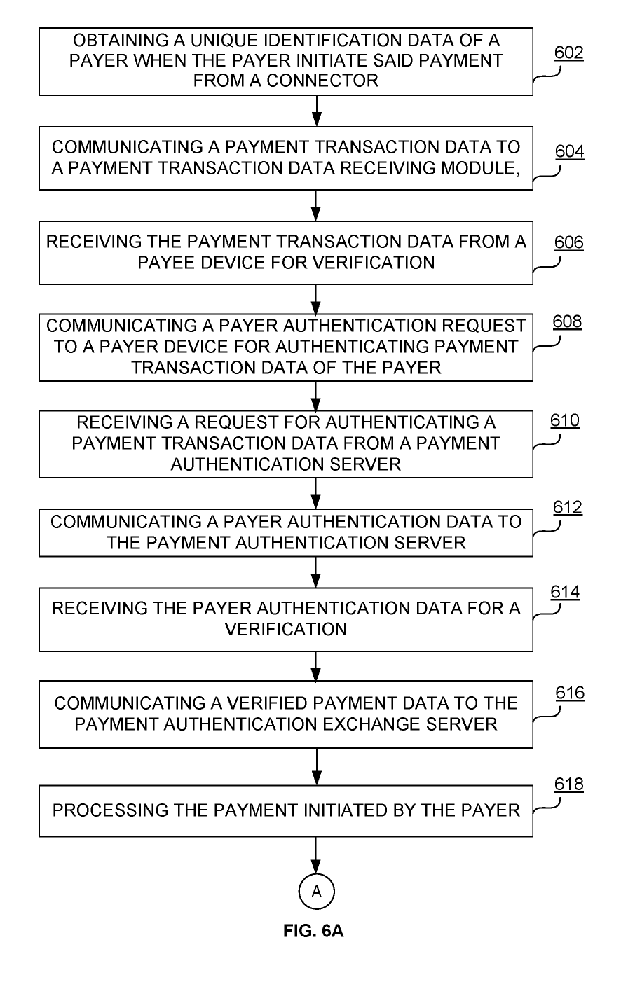

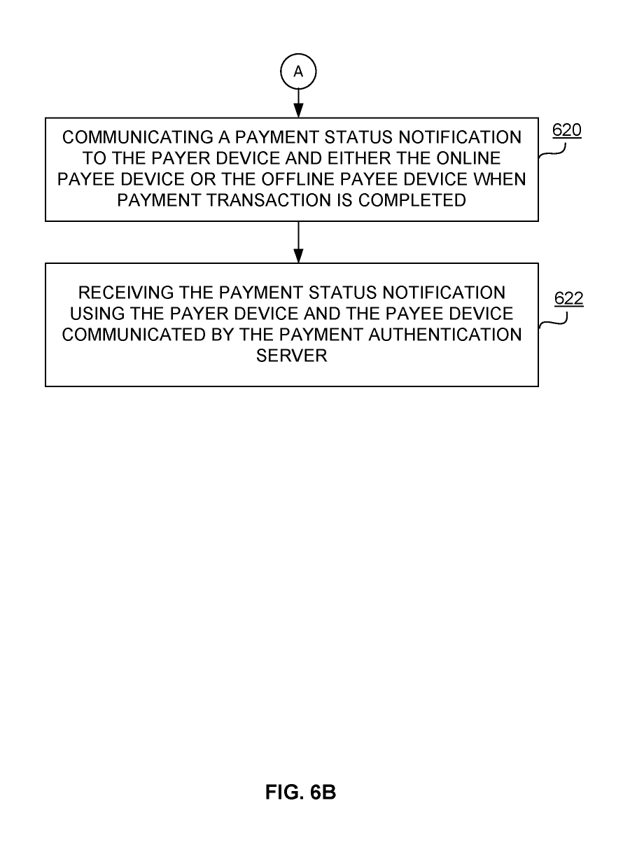

FIG. 6A-6B are flow diagrams illustrating a method of processing the payment transaction initiated by the payer 102 using the payer connector 104 and the payer device 110 to the payee 120 through the payment authentication server 108 of FIG. 1 according to an embodiment herein. At step 602, the unique identification data of the payer is obtained when the payer initiate the payment from the payer connector 104. At step 604, a payment transaction data is communicated to the payment transaction data receiving module. At step 606, the payment transaction data is received using the payment authentication server 108 from the online payee device 106 or the offline payee device 107 for verification. At step 608, the payment authentication server 108 sends the payer authentication request to the payer device 110. At step 610, a request for authenticating the payment transaction data is received from the payment authentication server 108 by the payer device 110. At step 612, a payer authentication data is communicated to the payment authentication server 108 using the payment authentication system 112 in the payer device 110, by the payer 102. At step 614, the payer authentication data is received by the payment authentication server 108 for the verification. At step 616, a verified payment data is communicated to the payment authentication exchange server 114. At step 618, the payment initiated by the payer 102 is processed by a payment authentication exchange server 114. At step 620, a payment transaction status notification is communicated to the payer device 110 and the payee device 106 when payment transaction is completed. At step 622, the payment status notification communicated is received by the payment authentication server 108. In one embodiment, the payment transaction data includes (a) the unique identifier of said payer 102 and (b) the payment data of said payee 120 which is required for processing said payment.

According to one embodiment, the payee 120 is identified by comparing the payment transaction data with the payee data store in a payment server database 202. In one embodiment, the payer device 110 is a mobile phone. In one embodiment, the payer 102 is authenticated by comparing the payer authenticating data with the payer data stored in said payment server database 202. According to one embodiment, the payment authentication exchange server 114 communicates with both a payer bank server 116 and a payee bank server 118 for processing the payment. According one embodiment, the notification includes at least one of (i) the payment transaction is successful, (ii) the payment transaction is cancelled, or (iii) the payment transaction is pending.

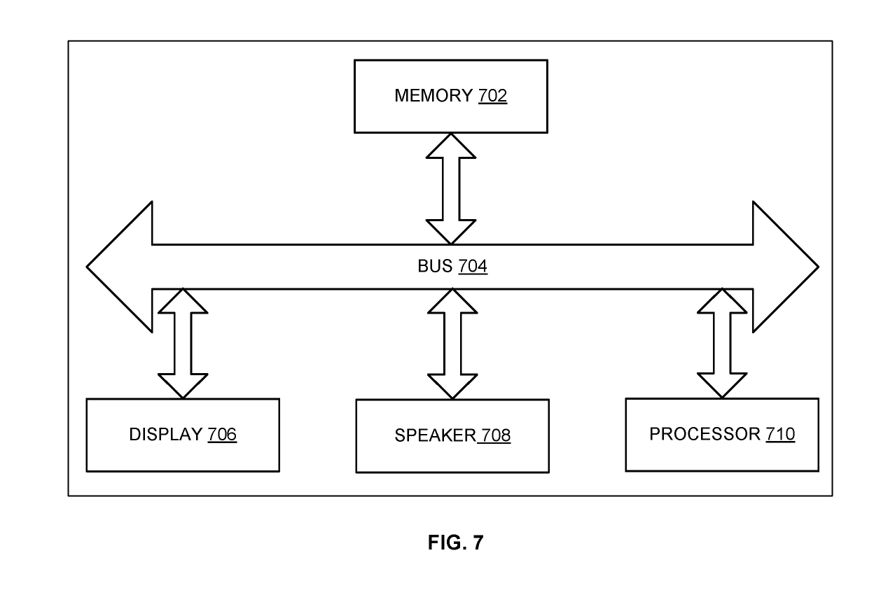

FIG. 7 illustrates an exploded view 700 of the personal communication device having an a memory 702 having a set of computer instructions, a bus 704, a display 706, a speaker 708, and a processor 710 capable of processing a set of instructions to perform any one or more of the methodologies herein, according to an embodiment herein. In one embodiment, the receiver may be the personal communication device. The processor 710 may also enable digital content to be consumed in the form of video for output via one or more displays 706 or audio for output via speaker and/or earphones 708. The processor 710 may also carry out the methods described herein and in accordance with the embodiments herein.

Digital content may also be stored in the memory 702 for future processing or consumption. The memory 702 may also store program specific information and/or service information (PSI/SI), including information about digital content (e.g., the detected information bits) available in the future or stored from the past. A user of the personal communication device may view this stored information on display 806 and select an item of for viewing, listening, or other uses via input, which may take the form of keypad, scroll, or other input device(s) or combinations thereof. When digital content is selected, the processor 710 may pass information. The content and PSI/SI may be passed among functions within the personal communication device using the bus 704.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

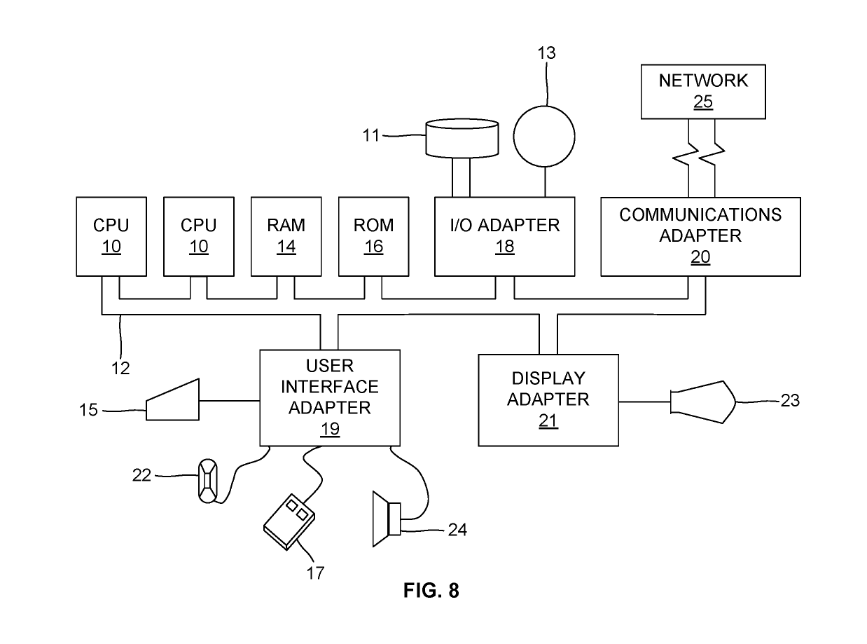

A representative hardware environment for practicing the embodiments herein is depicted in FIG. 8. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The system and method using payment authentication system 112 along with the payment authentication server 108 is versatile and allows one or more payers 102 to securely transfer the payment to one or more payees 120 in either 2-factor authentication or 3-factor authentication. This method of payment transaction is devoid of traditional way of payment involving CVV number or OTP. Further, the payers can get rid of fraudulent act of using credit card and the CVV number of the payer, as this method requires the payer device 110 also for authorization of payment. As the payment transaction is happening through 2 separate networks, (i.e., credit card number given in payee device 106 is sent to the payment authentication server 108 and the payer authentication data is sent through the payer device 110 to the payment authentication server 108) it is very hard to crack the process involved. In both online and offline mode of payment transactions there is no place for misuse of the payment cards and passwords. The two separate networks involved cannot be found on the same place and the fraudster will get either one of the details only, on the act of theft which is turned to be useless without the other network of authorization. The method have several uses such as the payer 102 can give the connector 104 or the credit card to a staff, a maid, a child, a spouse to buy the stuff from the payee and the authorization will come to the payer mobile to authenticate the payment transaction.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A payment authentication server 108 for authenticating a transaction between a payer 102 and a payee 120, said payment authentication server 108 comprising:
a memory unit that stores (a) a set of modules, and (b) a payment server database 202, wherein said payment server database 202 stores (a) a payer data that comprises at least one of (i) a payer connector 104 or identifying information (ii) said payer name, (iii) payer bank account details, (iv) a PIN number, (v) a Mobile Number and Machine/Software ID, (vi) a password, (vii) a finger print of said payer, and (viii) an iris scan of said payer,(viii) private and public key pairs used to establish identity and (b) a payee data comprises, (i) payee name, (ii) payee identifier information and (iii) payee bank account details; and
a processor which executes said set of modules, wherein said set of modules comprises:
a payment transaction data receiving module 204 configured to (i) receive a payment transaction data from a payee device 110 when said payment is initiated by said payer 102 using said payer connector 104 or a payee bank server 118 when said payment is initiated by said payer 102 by entering a unique identifying number on said payee online device 106 or said payee offline device 107, and (ii) identifies said payer 102 by comparing said payment transaction data with said payer data stored in said payment server database 202, wherein said payment transaction data comprises (a) a unique identifier of said payer, and (b) a payment data of said payee 102 which is required for processing said payment;
a payer authentication request module 206 configured to communicate a request to said payer device 110 for authenticating said payment transaction data of said payer 102;
a payer authentication receiving module 208 configured to receive said payer authentication data from said payer device 110 for verification, wherein said payer authentication data is verified by comparing said payer authentication data with said payer data stored in said payment server database 202, wherein said payer authentication data comprises at least one of i) said mobile number, machine ID or software ID on device (ii) said password in a 2^{nd} factor authentication, (iii) a fingerprint or an Iris scan or (iv) Encryption key pairs in a 3 factor authentication.
a payment transaction module 210 configured to communicate said payment information to a payment authentication exchange server 114 to initiate a payment transaction when said payer authentication is verified, wherein said payment authentication exchange server 114 communicates with a payer bank server 116 and a payee bank server 118 to process said payment; and
a payment transaction status notification module 212 configured to communicate a notification to said payer device 110 and either said online payee device 106 or said offline payee device 107 when said payment transaction is completed, wherein said notification comprises at least one of (i) said payment transaction is successful, (ii) said payment transaction is cancelled, or (iii) said payment transaction is pending.

2. The payment authentication server as claimed in claim 1, wherein said payer device 110 comprises:
a payer authentication request receiving module 304 configured to receive said request from said payment authentication server 108 to allow said payer 102 to provide said payer authentication data;
a payer authentication data communication module 306 configured to communicate said payer authentication data to said payment authentication server 108; and
a payment transaction status notification receiving module 308 configured to receive said notification from said payment authentication server 108.

3. The payment authentication server 108 as claimed in claim 1, wherein said either online payee device 106 or offline payee device 107 comprises:
a unique identification data obtaining module 404 configured to obtain said unique identification data of said payer 102 when said payer 102 initiate said payment from said connector 104 or payee bank server;
a payment transaction data communication module 406 configured to communicate said payment transaction data to said payment authentication server 108; and
a payment transaction status notification receiving module 408 configured to receive said notification from said payment authentication server 108.

4. The payment authentication server 108 as claimed in claim 1, wherein said payer 102 communicates payer authentication data to said payment authentication server 108 only using said payer device 110.

5. The payment authentication server 108 as claimed in claim 1, wherein said payer connector 104 is a credit card, or a debit card, wherein said payer payment data is stored in said connector 104 using at least one of a) a QR code, b) a sound tag, c) chip technology, d) magnetic strip, e) RFID or f) Plain printed numbers or text.

6. The payment authentication server 108 as claimed in claim 1, wherein said payment authentication server 108 is connected to a plurality of a) payer devices 110, b) online payee devices 106 and c) offline payee devices 107 for processing said payment initiated by said plurality of payers 102.

7. The payment authentication server 108 as claimed in claim 1, wherein payer authentication data further comprises: (i) a mobile number, (ii) a machine ID, (iii) a software ID of said registered payer device 110 or (iv) encryption key pairs used to establish identity.

8. A method for processing a payment initiated by a payer 102 using a connector 104 and a payer device 110 to a payee 120 through a payment authentication server, comprising:
obtaining, using either a online payee device 106 or an offline payee device 107, a unique identification data of said payer 102 when said payer 102 initiate said payment from a connector 104;
communicating, using said payment transaction data communication module 406, a payment transaction data to said payment authentication server, wherein said payment transaction data comprises (a) said unique identifier of said payer 102 and (b) a payment data of said payee 120 which is required for processing said payment;
receiving, using said payment transaction data receiving module 204, said payment transaction data from said payee online device 106 or said payee offline device 107 for verification, wherein said payer 102 is identified by comparing payment transaction data with a payer data store in a payment server database 202;
communicating, using a payment authentication server 108, a payer authentication request to a payer device 110 for authenticating said payment transaction data of said payer 102, wherein in said payer device 110 is a mobile phone;
receiving, using said payer device 110, a request for authenticating said payment transaction data from said payment authentication server 108;
communicating, using said payer device 110, a payer authentication data to said payment authentication server 108;
receiving, using said payment authentication server 108, said payer authentication data for said verification, wherein said payer 102 is authenticated by comparing said payer authenticating data with said payer data stored in said payment server database 202;
communicating, using payment authentication server 108, a verified payment data to said payment authentication exchange server 114, that is required to process said payment initiated by said payer 102;
processing, using said payment authentication exchange server 114, said payment initiated by said payer 102, wherein said payment authentication exchange server 114 communicates with both a payer bank server 116 and a payee bank server 118 for processing said payment;
communicating, using payment authentication server 108, a payment status notification to said payer device 110 and payee online device 106 or said payee offline device 107 when payment transaction is completed, wherein said notification comprises at least one of (i) said payment transaction is successful, (ii) said payment transaction is cancelled, or (iii) said payment transaction is pending; and
receiving, using said payer device 110 and payee online device 106 or said payee offline device 107, said payment status notification communicated by said payment authentication server 108.

9. The method as claimed in claim 8, wherein said payer data comprises at least one of: (i) said payer name, ii) payer bank account details, iii) a PIN number, (iv) a finger print, (v) an Iris scan, (vi) a password, (vii) a mobile number, (viii) a software ID on said payer device 110, (ix) a machine ID of said payer device 110, (x) encryption key pairs used to establish identity.

10. The method as claimed in claim 8, wherein said connector 104 is a credit card, or a debit card or a Unique Identifying number, wherein said payer payment data is stored in said connector 104 using at least one of a) a QR code, b) a sound tag, c) chip technology, d) magnetic strip, e) RFID, or f) written alphanumeric text.
